(19) United States
(12) Patent Application Publication
(10) Pub. No.: US 2026/0272041 A1
(43) Pub. Date: Sep. 17, 2026

(54) Aerosol Generation Device Battery Monitoring

(71) Applicant: JT International SA, Geneva (CH)

(72) Inventor: Grzegorz Aleksander Pilatowicz, Grens (CH)

(73) Assignee: JT International SA, Geneva (CH)

(21) Appl. No.: 19/168,514

(22) PCT Filed: Apr. 10, 2024
(86) PCT No.: PCT/EP2024/059745

§ 371 Date: Sep. 24, 2025

(30) Foreign Application Priority Data
Apr. 11, 2023 (EP) 23167404.5

(51) Int. Cl. A24F 40/53; A24F 40/57; A24F 40/90; H01M 10/44; H01M 10/48; H01M 50/581

(52) U.S. Cl. CPC A24F 40/53; A24F 40/57; A24F 40/90; H01M 10/443; H01M 10/486; H01M 50/581

(57) ABSTRACT

There is provided an aerosol generation device comprising a battery module, and a battery temperature sensor, and a controller. The controller is configured to monitor a temperature of the battery during charging of the battery to detect an indication of an end-of-charge temperature rise and determine whether the indication of the end-of-charge temperature rise has been detected in the monitored battery temperature. The controller controls the aerosol generation device to perform an action when the indication of the end-of-charge temperature rise is detected, and maintain the aerosol generation device in an operable state and not control the aerosol generation device to perform the action when the indication of the end-of-charge temperature rise is not detected.

### FIELD OF THE INVENTION

The present invention relates to aerosol generation devices, and more particularly battery monitoring in aerosol generation devices.

### BACKGROUND

Aerosol generation devices such as electronic cigarettes and other aerosol inhalers or vaporisation devices are becoming increasingly popular consumer products.

Heating devices for vaporisation or aerosolisation are known in the art. Such devices typically include a heating chamber and heater. In operation, an operator inserts the product to be aerosolised or vaporised into the heating chamber. The product is then heated with an electronic heater to vaporise the constituents of the product for the operator to inhale. In some examples, the product is a tobacco product similar to a traditional cigarette. Such devices are sometimes referred to as “heat not burn” devices in that the product is heated to the point of aerosolisation, without being combusted.

Aerosol generation devices are typically powered by a power system that includes a battery, and in particular a rechargeable battery. However, problems are faced in that such batteries degrade over time which can affect the user experience and can cause safety issues.

### SUMMARY OF INVENTION

An object of the present invention is to address the aforementioned problems, amongst others.

In a first aspect, there is provided an aerosol generation device comprising a battery module, and a battery temperature sensor, and a controller configured to: monitor a temperature of the battery during charging of the battery using the battery temperature sensor to detect an indication of an end-of-charge temperature rise in the monitored battery temperature; determine whether the indication of the end-of-charge temperature rise has been detected in the monitored battery temperature; control the aerosol generation device to perform an action when the indication of the end-of-charge temperature rise is detected; and maintain the aerosol generation device in an operable state and not control the aerosol generation device to perform the action when the indication of the end-of-charge temperature rise is not detected.

In an alternative first aspect of the invention there is provided an aerosol generation device comprising a battery module, and a battery temperature sensor, a battery charge sensor and a controller configured to: monitor the charge level of the battery during charging of the battery using the battery charge sensor; monitor a temperature of the battery during charging of the battery using the battery temperature sensor to detect an indication of an end-of-charge temperature rise in the monitored battery temperature; determine whether the indication of the end-of-charge temperature rise has been detected in the monitored battery temperature only when it is determined that the monitored charge level of the battery has exceeded a predetermined charge level threshold; control the aerosol generation device to perform an action when the indication of the end-of-charge temperature rise is detected; and maintain the aerosol generation device in an operable state and not control the aerosol generation device to perform the action when the indication of the end-of-charge temperature rise is not detected.

In this way, the detection of an end-of-charge temperature rise (ECTR) event can be used to determine that a battery has degraded and may need to be replaced in an aerosol generation device. The detection of an ECTR event is beneficial in identifying degradation mechanisms (such as lithium plating that can cause micro-short circuits) with relatively slow kinetics that can eventually lead to a sudden drop in the performance of the battery, as well as safety issues. Improvements in battery monitoring are therefore provided. Preferably, the indication of an end-of-charge temperature rise comprises an increase in the temperature of the battery exceeding a threshold rate of temperature change.

In this way, through comparing rate of change the monitored battery temperature to a predetermined threshold rate of change, an ECTR event can be detected.

Preferably, the controller is configured to monitor the temperature of the battery during charging of the battery using the battery temperature sensor by measuring the temperature of the battery at predetermined time intervals during the charging; and detect the indication of an end-of-charge temperature rise in the temperature of the battery measured at the predetermined time intervals when an increase in the temperature of the battery exceeds the threshold rate of temperature change.

In this way, the battery temperature can be monitored at intervals, and the change in battery temperature between these intervals can be used to detect an ECTR event.

Preferably, the aerosol generation device further comprises a battery charge level monitoring subcircuit, and the controller is configured to determine the charge level of the battery using the battery charge level monitoring subcircuit; and the controller is further configured to: monitor the temperature of the battery during charging of the battery to detect the indication of the end-of-charge temperature rise in the monitored battery temperature when the charge level of the battery exceeds a predetermined charge level threshold; and not monitor the temperature of the battery during charging of the battery to detect an indication of the end-of-charge temperature rise in the monitored battery temperature when the charge level of the battery does not exceed the predetermined charge level threshold.

In this way, the battery temperature is only monitored for an ECTR event at the point in the charging cycle at which the ECTR event would be expected to occur. This reduces the likelihood of detecting a false positive ECTR event due to temperature changes that occur at points in the charging cycle other than at the end-of-charge.

Preferably, the controller is configured to determine whether the temperature of the battery is within a predetermined temperature range, and the controller is further configured to: monitor the temperature of the battery during charging of the battery to detect the indication of an end-of-charge temperature rise during the charging of the battery when the temperature of the battery is within the predetermined temperature range; and not monitor the temperature of the battery during charging of the battery to detect an indication of the end-of-charge temperature rise during the charging of the battery when the temperature of the battery is not within the predetermined temperature range.

If the battery temperature is not within the predetermined temperature range (for example if the temperature is too high or too low), it may not be possible to accurately determine whether an ECTR event has occurred, thereby leading to false negative or false positive determinations of an ECTR event. As such, in the aforementioned way, the likelihood of a false negative or false positive determination of an ECTR event is reduced.

Preferably, in response to a new battery being connected to the aerosol generation device, the controller is configured to repeatedly, in a looped manner wherein each loop corresponds to a separate and consecutive battery charging cycle, monitor the temperature of the battery when charging to detect an indication of an end-of-charge temperature rise in the monitored battery temperature and determine whether the indication of the end-of-charge temperature rise has been detected; and maintain the aerosol generation device in the operable state when the indication of the end-of-charge temperature rise is not detected in n loops, wherein n has a predetermined value that is integer greater than 1; and control the aerosol generation device to perform the action when the indication of the end-of-charge temperature rise is detected in the n loops.

When a battery is subject to an extended period at a low state-of-charge before being charged (e.g., a long shelf time), the battery health can degrade. In the aforementioned way, a newly connected battery can be checked for degradation through the detection of an ECTR event in its first n charging cycles. This improves reliability as it is determined whether such a new battery is already degraded.

Preferably, for each loop in which the indication of the end-of-charge temperature rise is not detected, the controller increases a loop count by 1, and the controller is configured to stop the looped monitoring the temperature of the battery for the indication of the end-of-charge temperature rise and maintain the aerosol generation device in the operable state when the loop count reaches n.

In this way, when it is determined that the newly inserted battery is of good health (i.e., no ECTR event has occurred in the first n charging cycles), the controller can stop monitoring for an ECTR event, thereby saving processing resources.

Preferably, n=5.

Preferably, the controller is configured to detect that the battery is charging before monitoring the temperature of the battery during charging of the battery using the battery temperature sensor to detect the indication of an end-of-charge temperature rise in the monitored battery temperature.

In this way, there is a reduction in the likelihood of detecting a false positive ECTR event due to temperature changes that occur during usage or storage of the aerosol generation device, rather than when the battery is being charged. Also, processing resources are saved by only monitoring for an ECTR event when one might be expected to occur (i.e., during charging).

Preferably, the action comprises providing an output by an indicator of the aerosol generation device indicating that the battery is degraded.

In this way, the operator of the operator is made aware of the internal state of the system. Such an indicator can be beneficial in alerting the user that there is a battery issue that should be investigated, or the battery should be replaced, whilst still allowing the user to perform further charging of the battery and/or further aerosolisation sessions. This is useful when the battery issue is one that is non-critical (at least in the short-term). For example, if the ECTR event occurs in a new (or relatively) new battery it may be non-critical to the operation of the aerosol generation device thereby not preventing aerosolisation sessions from occurring, whilst the user can be made aware as such a non-critical issue could still negatively impact the operation of the device or the quality of an aerosolisation session.

Preferably, the action comprises deactivating the aerosol generation device.

In this way, safety can be improved when there is a critical issue with the battery. For example, if an ECTR event occurs with a much greater temperature rise there could be a serious problem with the battery that poses a safety risk. Deactivating the aerosol generation device in response to such an issue can help to mitigate this risk.

Preferably, the action comprises: providing an output by an indicator of the aerosol generation device indicating that the battery is degraded when a detected end-of-charge temperature rise has a rate of temperature change that is greater than a first predetermined rate of temperature change but not greater than a second predetermined rate of temperature change, wherein the second predetermined rate of temperature change is greater than the first predetermined rate of temperature change; and deactivating the aerosol generation device when a detected end-of-charge temperature rise has a rate of temperature change that is greater than the second predetermined rate of temperature change.

In this way, a balance can be provided between alerting the operator to a non-critical battery degradation (i.e., when the detected end-of-charge temperature rise has a rate of temperature change that is greater than the first predetermined rate of temperature change), and deactivating the device for safety when the detected end-of-charge temperature rise has a rate of temperature change that is greater than the second predetermined rate of temperature change.

Preferably, deactivating the aerosol generation device comprises preventing the device from performing one or more aerosolisation sessions and/or preventing the battery from being charged.

Preferably, the aerosol generation device is configured to aerosolise an aerosol generating consumable for an aerosolisation session. Preferably, the aerosol generating consumable comprises an aerosol generating material. Preferably the aerosol generation device is configured to heat the aerosol generating material to generate the aerosol without burning the aerosol generating material. Preferably, the aerosol generating material comprises tobacco.

The controller may be configured to determine a fall in the temperature of the battery after the indication of the end-of-charge temperature rise has been detected in the monitored battery temperature. The controller may control the aerosol generation device to perform an action when the indication of the end-of-charge temperature rise is detected followed by a fall in the temperature of the battery. It has been found that a ECTR event is often associated with an increase in temperature followed by a decrease in temperature. The detection of this characteristic battery temperature profile in circumstances where the charge level of the battery is above the predetermined battery charge level threshold may confirm an ECTR event that is associated with battery degradation. In some circumstances the decrease in temperature may be determined by monitoring the first derivative of the temperature of the battery and the temperature decrease may be associated with a first derivative that is less than zero, or is less than a predetermined negative threshold value.

In a second aspect, there is a provided a method of monitoring an aerosol generation device battery, the method comprising: monitoring a temperature of a battery of an aerosol generation device during charging of the battery using a battery temperature sensor of the aerosol generation device to detect an indication of an end-of-charge temperature rise in the monitored battery temperature; determining whether the indication of the end-of-charge temperature rise has been detected in the monitored battery temperature; controlling the aerosol generation device to perform an action when the indication of the end-of-charge temperature rise is detected; and maintaining the aerosol generation device in an operable state and not controlling the aerosol generation device to perform the action when the indication of the end-of-charge temperature rise is not detected.

In an alternative second aspect, there is provided a method of monitoring an aerosol generation device battery, the method comprising: monitoring a temperature of a battery of an aerosol generation device during charging of the battery using a battery temperature sensor of the aerosol generation device to detect an indication of an end-of-charge temperature rise in the monitored battery temperature; monitor the charge level of the battery during charging of the battery using a battery charge sensor; determining whether the indication of the end-of-charge temperature rise has been detected in the monitored battery temperature only when it is determined that the monitored charge level of the battery has exceeded a predetermined charge level threshold; controlling the aerosol generation device to perform an action when the indication of the end-of-charge temperature rise is detected; and maintaining the aerosol generation device in an operable state and not controlling the aerosol generation device to perform the action when the indication of the end-of-charge temperature rise is not detected.

In a third aspect, there is provided a non-transitory computer-readable medium comprising instructions that when executed by one or more processors of an aerosol generation device cause the processors to: monitor a temperature of a battery of the aerosol generation device during charging of the battery using a battery temperature sensor of the aerosol generation device to detect an indication of an end-of-charge temperature rise in the monitored battery temperature; determine whether the indication of the end-of-charge temperature rise has been detected in the monitored battery temperature; control the aerosol generation device to perform an action when the indication of the end-of-charge temperature rise is detected; and maintain the aerosol generation device in an operable state and not control the aerosol generation device to perform the action when the indication of the end-of-charge temperature rise is not detected.

In an alternative third aspect, there is provided a non-transitory computer-readable medium comprising instructions that when executed by one or more processors of an aerosol generation device cause the processors to: monitor a temperature of a battery of the aerosol generation device during charging of the battery using a battery temperature sensor of the aerosol generation device to detect an indication of an end-of-charge temperature rise in the monitored battery temperature; monitor the charge level of the battery during charging of the battery using a battery charge sensor; determine whether the indication of the end-of-charge temperature rise has been detected in the monitored battery temperature only when it is determined that the monitored charge level of the battery has exceeded a predetermined charge level threshold; control the aerosol generation device to perform an action when the indication of the end-of-charge temperature rise is detected; and maintain the aerosol generation device in an operable state and not control the aerosol generation device to perform the action when the indication of the end-of-charge temperature rise is not detected.

Preferably, the preferably features of the first aspect and its alternative can also be included in the second and third aspects, and their alternatives, as appropriate.

### BRIEF DESCRIPTION OF DRAWINGS

Embodiments of the invention are now described, by way of example, with reference to the drawings, in which:

FIG. 1 is a block diagram of an aerosol generation device;

FIGS. 2A to 2C show plots characteristics of a new and healthy battery not demonstrating ECTR;

FIGS. 2D to 2F show plots of characteristics of a battery that does exhibit ECTR;

FIG. 3 is a flow diagram of a process of determining that a battery is degraded by detecting an ECTR event; and

FIG. 4 is a flow diagram of a process based on the process FIG. 3 performed in a looped manner for a detecting an ECTR event in a newly connected battery.

### DETAILED DESCRIPTION

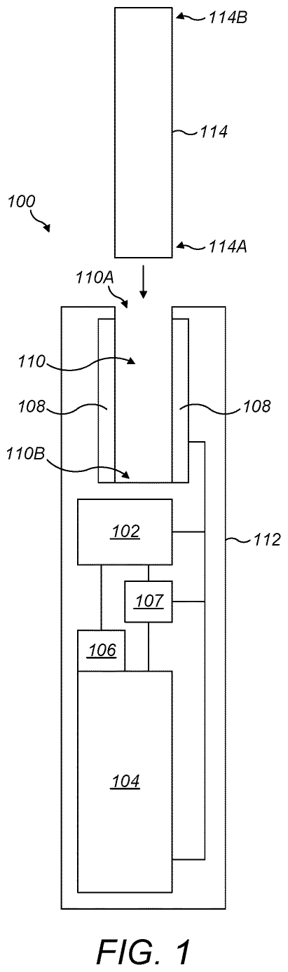

FIG. 1 shows a block diagram of the components of an aerosol generation device 100 or a vapor generation device, also known as an electronic cigarette. For the purposes of the present description, it will be understood that the terms vapor and aerosol are interchangeable.

The aerosol generation device 100 has a body portion 112 containing a controller 102, and a power system comprising a battery 104. Whilst described as a single battery herein, the battery 104 can be one or more batteries or battery pack(s).

The controller 102 is arranged to control the operation of the aerosol generation device 100. This can include inhibiting and enabling the operation of the device, as well as controlling a power flow of the battery 104 based upon the operating mode of the aerosol generation device. The controller 102 can be at least one microcontroller unit comprising memory, with instructions stored thereon for operating the aerosol generation device 100 including instructions for inhibiting and enabling the operation of the device, instructions for executing operating modes of the device, instructions for controlling the power flow from the battery, and the like, and one or processors configured to execute the instructions.

In an example, a heater 108 is contained with the body portion 112. In such an example, as shown in FIG. 1, the heater 108 is arranged in a cavity 110 or chamber in the body portion 112. The cavity 110 is accessed by an opening 110A in the body portion 112. The cavity 110 is arranged to receive an associated aerosol generating consumable 114. The aerosol generating consumable can contain an aerosol generating material, such as a tobacco rod containing tobacco. A tobacco rod can be similar to a traditional cigarette. The cavity 110 has cross-section approximately equal to that of the aerosol generating consumable 114, and a depth such that when the associated aerosol generating consumable 114 is inserted into the cavity 110, a first end portion 114A of the aerosol generating consumable 114 reaches a bottom portion 110B of the cavity 110 (that is, an end portion 110B of the cavity 110 distal from the cavity opening 110A), and a second end portion 114B of the aerosol generating consumable 114 distal to the first end portion 114A extends outwardly from the cavity 110. In this way, a consumer can inhale upon the aerosol generating consumable 114 when it is inserted into the aerosol generation device 100. In the example of FIG. 1, the heater 108 is arranged in the cavity 110 such that the aerosol generating consumable 114 engages the heater 108 when inserted into the cavity 110. In the example of FIG. 1, the heater 108 is arranged as a tube in the cavity such that when the first end portion 114A of the aerosol generating consumable is inserted into the cavity the heater 108 substantially or completely surrounds the portion of the aerosol generating consumable 114 within the cavity 110. The heater 108 can be a wire, such as a coiled wire heater, or a ceramic heater, or any other suitable type of heater. The heater 108 can comprise multiple heating elements sequentially arranged along the axial length of the cavity that can be independently activated (i.e. powered up) in a sequential order.

In an alternative embodiment (not shown), the heater can be arranged as an elongate piercing member (such as in the form of needle, rod or blade) within the cavity; in such an embodiment the heater can be arranged to penetrate the aerosol generating consumable and engage the aerosol generating material when the aerosol generating consumable is inserted into the cavity.

In another alternative embodiment (not shown), the heater may be in the form of an induction heater. In such an embodiment, a heating element (i.e., a susceptor) can be provided in the consumable, and the heating element is inductively coupled to the induction element (i.e., induction coil) in the cavity when the consumable is inserted into the cavity. The induction heater then heats the heating element by induction.

It will be understood from the foregoing that the heater 108 can be a heater component such as a heating element or induction coil. Hereinafter, such a heater component is referred to the as a heater, although it will be understood that this term can refer to any of the aforementioned heater components as well as a heater more generally.

The heater 108 is arranged to heat the aerosol generating consumable 114 to a predetermined temperature to produce an aerosol in an aerosolisation session. An aerosolisation session can be considered as when the device is operated to produce an aerosol from the aerosol generating consumable 114. In an example in which the aerosol generating consumable 114 is a tobacco rod, the aerosol generating consumable 114 comprises tobacco. The heater 108 is arranged to heat the tobacco, without burning the tobacco, to generate an aerosol. That is, the heater 108 heats the tobacco at a predetermined temperature below the combustion point of the tobacco such that a tobacco-based aerosol is generated. The skilled person will readily understand that the aerosol generating consumable 114 does not necessarily need to comprise tobacco, and that any other suitable substance for aerosolisation (or vaporisation), particularly by heating without burning the substance, can be used in place of tobacco.

The aerosol generation device 100 of FIG. 1 is only an example of a type of aerosol generation device that can be used. Alternative devices may be configured to receive consumables that are planar cartridges containing an aerosol generating material such as tobacco. Other alternative devices may be configured to receive loose tobacco as the aerosol generating consumable. In other alternatives, the aerosol generating consumable can be a vaporisable liquid. The vaporisable liquid can be contained in a cartridge receivable in the aerosol generation device or can be directly deposited into the aerosol generation device.

The aerosol generation device 100 comprises a battery temperature sensor 106. The controller 102 is configured to monitor the temperature of the battery 104 using the battery temperature sensor 106. In some examples, the battery temperature sensor may be a thermistor. In other examples, the battery temperature sensor 106 may be a sub-circuit specifically designed to measure the temperature of a battery.

The aerosol generation device 100 can also comprise a battery charge level monitoring subcircuit 107. The controller 102 can be configured to determine the charge level of the battery 104 using the battery charge level monitoring subcircuit 107. In some examples, the battery charge level monitoring subcircuit is a specifically designed subcircuit that is configured to monitor battery characteristics, such as a battery fuel gauge or battery fuel gauge chip. The battery charge level monitoring subcircuit 107 is just one implementation of a battery charge sensor. In another arrangement the battery charge sensor comprises a current sensor that can monitor the amount of current supplied to the battery 104. The state of charge of the battery 104 can be inferred by integrating the current supplied to the battery 104 over time. Of course, current can be measured or inferred in other ways such as by measuring the voltage drop across a resistor with known resistance.

The controller 102 is also arranged to control the power flow of the battery 104 in the aerosolisation session. In some examples, the aerosolisation session can include a preheating phase and a heating phase. In the preheating phase, the heater 108 associated with the aerosol generation device 100 is heated to a predetermined temperature for the generation of an aerosol from the aerosol generating consumable 114. The preheating phase can be considered the time during which a preheating mode is being executed, for example the time it takes for the heater 108 to reach the predetermined temperature. The preheating mode occurs during a first time period of the aerosolisation session. In an example, the first time period can be a fixed pre-determined time period. In other examples, the first time period can vary corresponding to the length of time needed to heat the heater 108 to the predetermined temperature. When the preheating phase is complete, the controller 102 ends the preheating mode and controls the power system to perform the heating phase. In the heating phase the controller 102 controls the power flow from the power system to maintain the heater 108 substantially at the predetermined temperature so that an aerosol is generated for the consumer to inhale. A heating phase can be considered the time during which a heating mode is being executed, for example the time during which the heater 108 is aerosolising one (or at least part of one) aerosol generating consumable 114 after the preheating phase. The controller 102 can control the power system to operate the heating mode for a second time period of the aerosolisation session. The second time period can be predetermined and stored at the controller 102.

The battery 104 is a rechargeable or secondary battery, such as a lithium-ion battery. To improve sustainability, an aged and/or degraded battery of an aerosol generation device can be replaced, rather than replacing the entire aerosol generation device.

Battery health degradation can be indicated through the end-of-charge temperature rise (ECTR) phenomenon. An ECTR event is a temperature rise near the end of the charging process. This is understood to be caused by lithium plating that can provoke a permanent internal short-circuit, indicative of battery health degradation, and causes safety issues. The effect can also be triggered by the battery having an extended period at a low state-of-charge before being charged (e.g., a shelf time that is too long).

An ECTR event occurs at high charging rates, such as >1 A; these are typical charging rates for heated tobacco applications.

ECTR events are self-terminating. For example, an ECTR event in one full charging session could fully terminate, or it may fully terminate over a plurality of charging sessions, such as two to five; this means that observation for a few charging events (for example five charging sessions) after replacement of the battery is sufficient to check for an ECTR event in a new battery.

The severity of an ECTR event is independent from charge-rate or pre-event impedance. Therefore, it may not be detected or indicated before a high state-of-charge is reached. ECTR also does not influence discharge capacity.

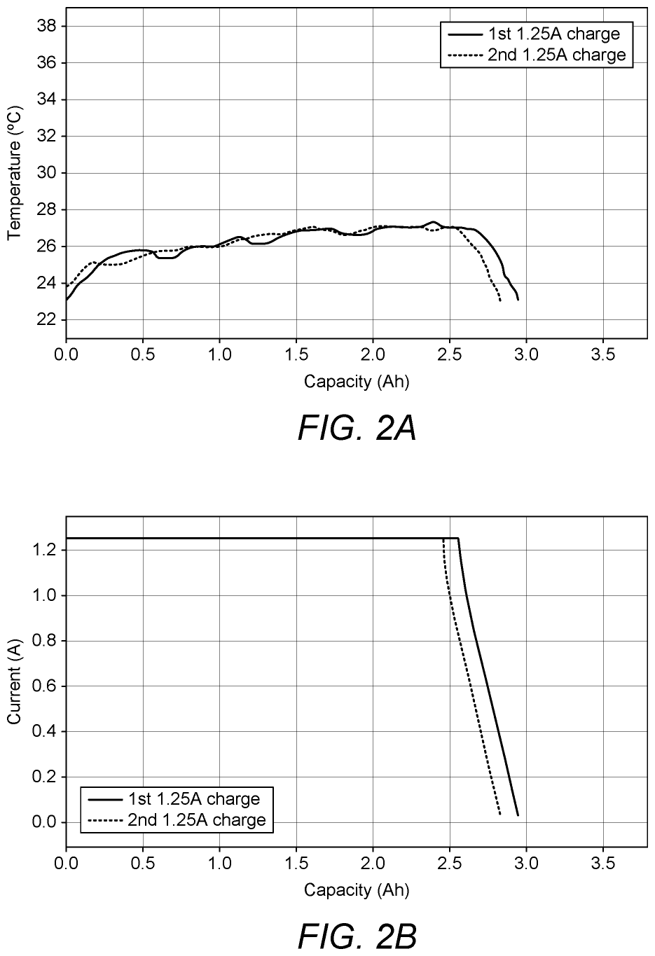

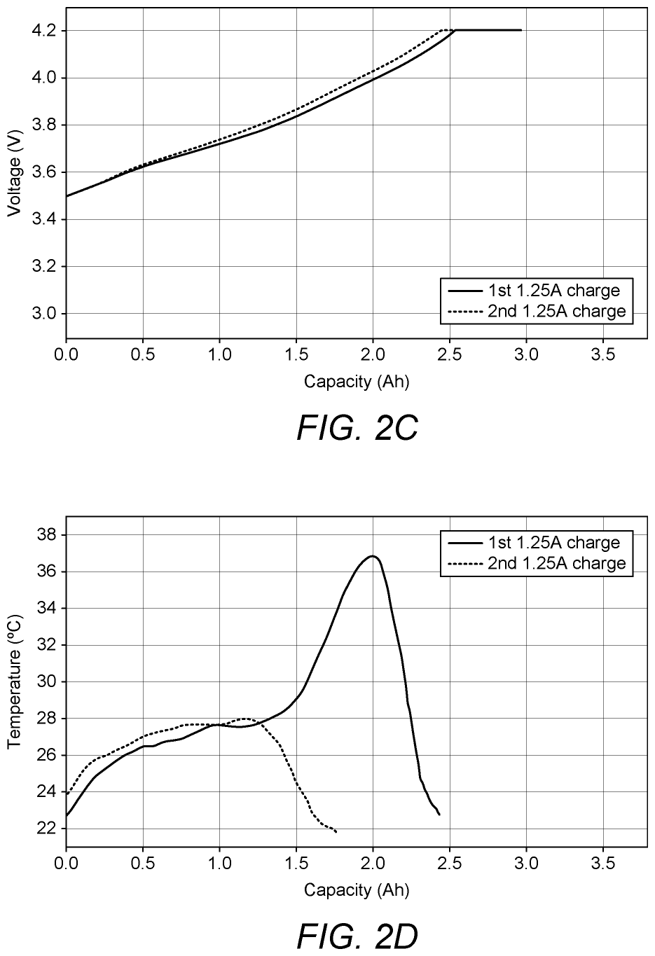

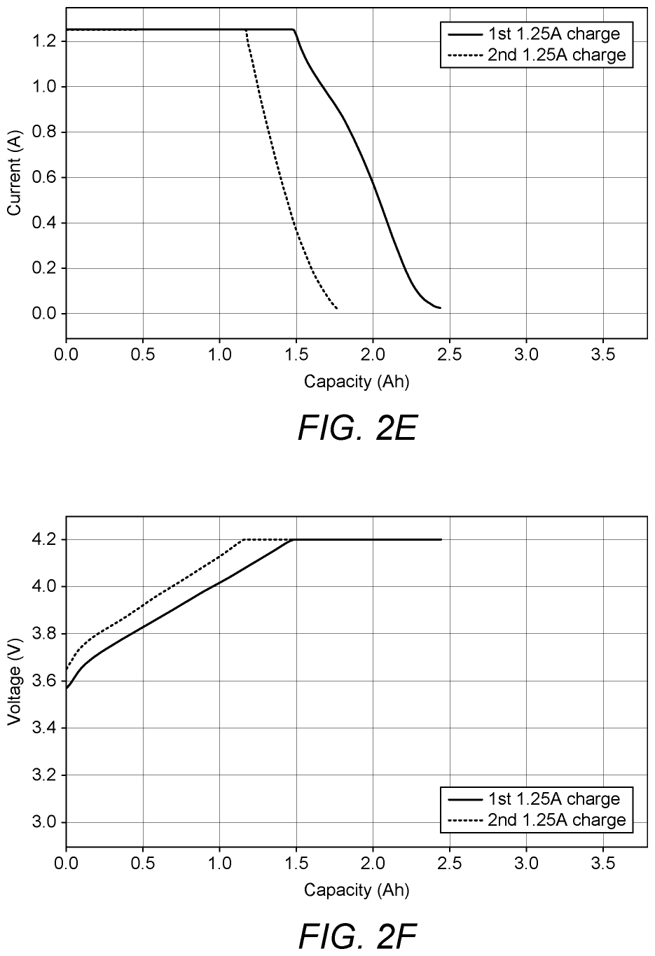

FIGS. 2A to 2C show plots characteristics of a new and healthy battery not demonstrating ECTR. FIGS. 2D to 2F show plots of characteristics of a battery that does exhibit ECTR. These figures are reproduced from: End-of-Charge Temperature Rise and State-of-Health Evaluation of Aged Lithium-Ion Battery, Energies, 2023, 16(1), 405; https://doi.org/10.3390/en16010405.

FIG. 2A shows a plot of battery temperature against capacity for a first and a second 1.25 A charge of a new battery. FIG. 2D shows a corresponding plot of battery temperature against capacity for a first and second 1.25 A charges but for a battery that demonstrates an ECTR event. As can be seen in FIG. 2D compared to FIG. 2A, there is a large temperature increase at the end of the charging cycle for the first charge; this is the ECTR event. For the second 1.25 A charge of the battery that demonstrated the ECTR event, the temperature spike is not present; this is understood to be due to ECTR being self-terminating.

FIG. 2C shows a plot of current against capacity for the first and second 1.25 A charges of a new battery. FIG. 2E shows a corresponding plot of current against capacity for the first and second 1.25 A charges of the battery that demonstrated an ECTR. As can be seen, after the ECTR event there is a current drop at higher capacities.

FIG. 2D shows a plot of voltage against capacity for the first and second 1.25 A charges of a new battery. FIG. 2F shows a corresponding plot of voltage against capacity for the first and second 1.25 A charges of the battery that demonstrated an ECTR. As can be seen, the battery capacity retention is greater than 80% (which is indicative of a theoretically good battery) after the ECTR; as such, a change in battery capacity may not be a fully comprehensive indicator of battery degradation. Additional metrics like ECTR are needed to make sure that the failure-rate in the field is as low as possible.

The detection of an ECTR event is beneficial in identifying degradation mechanisms (such as lithium plating that can cause micro-short circuits) with relatively slow kinetics that can eventually lead to a sudden drop in the performance of the battery, as well as safety issues.

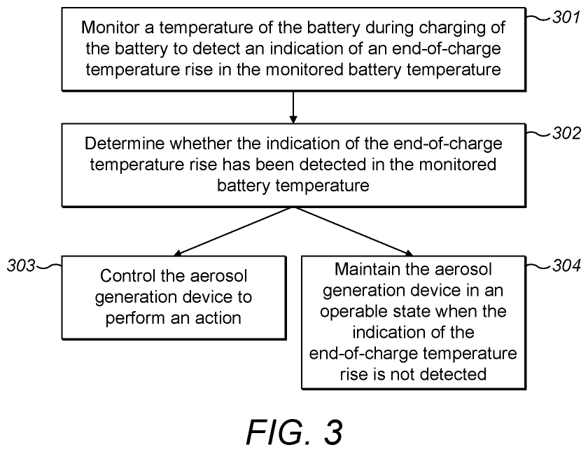

The detection of an ECTR event can be used to determine that a battery has degraded and may need to be replaced in an aerosol generation device. FIG. 3 shows a block diagram of how it can be determined that the battery has degraded, and further steps taken.

At step 301, the controller 102 monitors a temperature of the battery 104 during charging of the battery 104 using the battery temperature sensor 106 to detect an indication of an ECTR event in the monitored battery temperature.

The controller 102 can use the battery temperature sensor 106 to measure the battery temperature continuously or at predetermined time intervals (e.g., 10 second to 60 second intervals) while the battery 104 is charging. This can be triggered by the controller 102 detecting that the aerosol generation device has been connected to a charger, for example.

In some examples, the aerosol generation device 100 can also include a battery charge level monitoring subcircuit 107. The controller 102 can be configured to determine the charge level of the battery 104 using the battery charge level monitoring subcircuit 107.

Because the ECTR happens at the end of the charge cycle, the controller 102 can monitor the temperature of the battery 104 during charging of the battery to detect the indication of the ECTR event in the monitored battery temperature when the charge level of the battery exceeds a predetermined charge level threshold. The predetermined charge level threshold can be a charge level above which ECTR would be expected to occur for the type of battery being used. This predetermined charge level threshold can be stored in storage accessible by the controller 102. In an example, the predetermined charge level threshold may be 50% of the nominal capacity of the battery. In another example, the predetermined charge level threshold may be at least 30% of the nominal capacity of the battery.

Likewise, the controller 102 can also be configured to not monitor the temperature of the battery 104 during charging of the battery to detect an indication of the ECTR event in the monitored battery temperature when the charge level of the battery does not exceed the predetermined charge level threshold.

In this way, the battery temperature is only monitored for an ECTR event at the point in the charging cycle at which the ECTR event would be expected to occur. This reduces the likelihood of detecting a false positive ECTR event due to temperature changes that occur at points in the charging cycle other than at the end-of-charge.

The controller 102 can also be configured to detect that the battery is charging before monitoring the temperature of the battery 104 during charging of the battery using the battery temperature sensor 106 to detect the indication of an ECTR event in the monitored battery temperature. That is, the battery temperature monitoring is not triggered when the battery 104 is not charging. This reduces the likelihood of detecting a false positive ECTR event due to temperature changes that occur during usage or storage of the aerosol generation device 100, rather than when the battery 104 is being charged.

At step 302, the controller 102 determines whether the indication of the ECTR event has been detected in the monitored battery temperature.

When the indication of the ECTR event is detected, the process continues to step 303. When the indication of the ECTR event is not detected, the process continues to step 304.

The indication of an ECTR event can comprise an increase in the temperature of the battery 104 exceeding a threshold rate of temperature change.

The threshold temperature rate of change can be a predetermined value stored in storage accessible by the controller.

The controller 102 can be configured to monitor the temperature of the battery 104 during charging of the battery using the battery temperature sensor 106 by measuring the temperature of the battery at predetermined time intervals during the charging (i.e., monitoring the temperature gradient, or rate of change of the temperature). Then the controller 102 can detect the indication of the ECTR event in the temperature of the battery 104 measured at the predetermined time intervals when an increase in the temperature of the battery exceeds the threshold rate of temperature change.

The threshold rate of temperature change can be a maximum allowable change in temperature between the temperature measurements at the predetermined time intervals (i.e., a threshold temperature gradient, or threshold rate of change of the temperature). When the temperature change exceeds the maximum allowable change, the temperature increase can be considered indicative of an ECTR event. An example threshold rate of temperature change may be 6° C. in a given time interval, and a temperature change of >6° C. in the given time interval may be considered indicative of an ECTR event. The time interval between which consecutive temperature measurements are made may, for example, be in the range of 10 seconds to 1 minute.

In some examples there can be more than one threshold rate of temperature change. For example, there can be two thresholds. The first threshold rate of temperature change can correspond to a non-critical ECTR event. The second threshold rate of temperature change is higher than the first threshold rate of temperature change and can correspond to a critical ECTR event. In a specific example, the first threshold rate of temperature change may be 6° C. in a given time interval, and a temperature change of >6° C. in the given time interval (e.g., 10 seconds) may be considered indicative of a non-critical ECTR event; the second threshold rate of temperature change may be 20° C. in the given time interval, and a temperature change of >20° C. in the given time interval (e.g., 10 seconds) may be considered indicative of a critical ECTR event. In such examples with more than one threshold rate of temperature change, the action that performed by the controller in response to the detection of the ECTR event can correspond to the threshold rate of temperature change that has been passed. That is to say, detection that the battery temperature change has passed the first threshold rate of temperature change can trigger a different action to the detection that the battery temperature change has passed the second threshold rate of temperature change. This is discussed in more detail with regard to step 303.

The controller 102 can be configured to determine whether the temperature of the battery 104 is within a predetermined temperature range during the charging.

The predetermined temperature range can be a preferred operating temperature range of the battery. In an example, such a temperature range may be 15° C. to 40° C. The predetermined temperature range can be stored in storage accessible by the controller 102. The controller 102 can then compare the temperature of the battery 104 measured with the battery temperature sensor 106 to this predetermined temperature range.

If the battery temperature is not within the predetermined temperature range (for example if the temperature is too high or too low), it may not be possible to accurately determine whether an ECTR event has occurred, thereby leading to false negative or false positive determinations of an ECTR event. As such, when the battery temperature is not within the predetermined temperature range, the data is considered not valid for an ECTR check, and the controller 102 does not monitor the temperature of the battery 104 during charging of the battery to detect the indication of an ECTR event during the charging of the battery.

When the temperature of the battery 104 is within the predetermined temperature range, the controller 102 monitors the temperature of the battery during charging of the battery to detect the indication of an ECTR event during the charging of the battery. As mentioned, when the temperature of the battery 104 is not within the predetermined temperature range, the controller 102 does not monitor the temperature of the battery during charging of the battery to detect an indication of the ECTR event during the charging of the battery. In this way, the likelihood of a false negative or false positive determination of an ECTR event is reduced.

It is known that ECTR events can lead to an increase in battery temperature followed by a fall in battery temperature. Such a situation is illustrated in FIG. 2D in the first 1.25 A charge. The controller 102 can monitor the temperature of the battery to detect a fall in the temperature of the battery that immediately follows the end-of-charge temperature rise. This may be included as an optional requirement to confirm the ECTR event. In this way, the battery temperature can be monitored to detect a characteristic profile that is indicative of the ECTR event which comprises an increase in temperature followed by a decrease in temperature. These two aspects of the temperature profile can be identified by monitoring the first derivative of the temperature of the battery. In some embodiments the decrease in temperature may be identified by determining a first derivative of the temperature that is less than zero, or less than a predetermined negative threshold value.

At step 303, when the indication of the ECTR event is detected, the controller 102 controls the aerosol generation device 100 to perform an action.

In a first example, the action comprises providing an output by an indicator of the aerosol generation device indicating that the battery 104 is degraded.

The indicator can, for example, be an audio indicator (such as a speaker), a visual indicator (such as one or more lights, or a display screen), or a haptic indicator (such as a vibrating module). In the example of a display screen, the indication could include a message displayed to the user that alerts the user that the battery has an issue that should be investigated, or replaced. An audio indicator could convey a similar indication in an audible manner.

Such an indicator can be beneficial in alerting the user that there is a battery issue that should be investigated, or the battery 104 should be replaced, whilst still allowing the user to perform further charging of the battery 104 and/or further aerosolisation sessions. This is useful when the battery issue is one that is non-critical (at least in the short-term). For example, if the ECTR event occurs in a new (or relatively new) battery it may be non-critical to the operation of the aerosol generation device 100 thereby not preventing aerosolisation sessions from occurring, whilst the user can be made aware as such a non-critical issue could still negatively impact the operation of the device or the quality of an aerosolisation session. The action can further comprise locking the device if the operator does not then replace the battery within a predefined period of time (e.g., two weeks); this allows use of the non-optimal battery in the short-term, whilst avoiding issues in the longer term.

In a second example, the action comprises deactivating the aerosol generation device 100.

Deactivating the aerosol generation device 100 can comprise preventing the device from performing one or more aerosolisation sessions and/or preventing the battery 104 from being charged. This action can also include providing an indication to the operator using the indicator in the device (e.g., an audio, visual or haptic indicator) to prompt the user to replace the battery.

In such examples, the controller 102 can block the circuitry used for charging the battery 104 or performing an aerosolisation session using internal switches. Alternatively, or additionally, the controller can lock software/firmware of the device that is used for carrying out charging or aerosolisation sessions.

This can be beneficial when there is a critical issue with the battery 104. For example, if an ECTR event occurs with a much greater temperature rise there could be a serious problem with the battery that poses a safety risk. Deactivating the aerosol generation device 100 in response to such an issue can help to mitigate this risk.

The action can comprise both, or either, of providing an output by an indicator of the aerosol generation device indicating that the battery 104 is degraded or deactivating the aerosol generation device 100.

Using the example of two threshold rates of temperature change, when it is detected that the rate of battery temperature change has passed the first (lower) threshold rate of temperature change when charging, the controller 102 controls the indicator of the device to provide an output indicating that there is a battery issue that should be investigated, or to advise that the battery 104 should be replaced (i.e., there is a non-critical battery issue), but does not deactivate the aerosol generation device 100. Then if/when it is detected that the rate of battery temperature change has passed the second (higher) threshold rate of temperature change when charging, the controller deactivates the aerosol generation device 100 for safety.

In other words, when the detected end-of-charge temperature rise has a rate of temperature change that is greater than a first predetermined rate of temperature change but not greater than a second predetermined rate of temperature change an output is provided by an indicator of the aerosol generation device indicating that the battery is degraded. When a detected end-of-charge temperature rise has a rate of temperature change that is greater than the second predetermined rate of temperature change the aerosol generation device is deactivated. The second predetermined rate of temperature change is greater than the first predetermined rate of temperature change.

At step 304, when the indication of the ECTR event is not detected, the controller 102 maintains the aerosol generation device 100 in an operable state and does not control the aerosol generation device 100 to perform the action.

When no ECTR event is detected, the battery 104 can be considered to be healthy. Therefore, charging of the battery and/or the performing of aerosolisation sessions are not inhibited, and normal usage of the aerosol generation device can be performed.

The processes and teaching described with reference to FIG. 3 can be implemented in a battery testing process for a new battery connected to the aerosol generation device 100. For example, when a new battery 104 is connected to or inserted into the aerosol generation device 100, the controller 102 can perform checks to confirm that the battery 104 is a verified battery (e.g., a battery of a type suitable for use in the device) by checking the battery characteristics. If the newly connected battery passes these checks, the aerosol generation device 100 can be unlocked by the controller 102 and used for a predetermined number of charge cycles (for example, 3 to 5 full charges with at least 50% of the nominal capacity being charged). During charging in these charge cycles, the process of FIG. 3 is performed. Through this, it can be determined whether the new and verified battery is already degraded by the presence or absence of an ECTR event. In this way, if an ECTR event is present, the user can be alerted that the battery is degraded. A new battery may be already degraded if, for example, it has been kept in a low state of charge for too long during storage.

For this, the process described with reference to FIG. 3 can be carried out in a looped manner in response to a new battery being connected to the aerosol generation device 100. The controller 102 can be configured to repeatedly, in a looped manner, monitor the temperature of the battery 104 when charging to detect an indication of an ECTR event in the monitored battery temperature (i.e., as in step 301) and determine whether the indication of the ECTR event has been detected (i.e., as in step 302). The loops can each correspond to separate and consecutive battery charging cycles. That is, each loop corresponds to a battery charging session, and the loop repeats for each charging session.

When the indication of the ECTR event is not detected in n loops, the controller 102 maintains the aerosol generation device 100 in the operable state (i.e., as in step 304). That is, the newly connected battery 104 is determined to be a battery in good health. For this, n can be an integer greater than 1. In a specific example, n can be equal to 5. In another example, n may be equal to 3. In further examples, n may be any suitable positive integer value. For each loop in which the indication of the ECTR event is not detected, the controller 102 can increase a loop count by 1. The controller 102 can then be configured to stop the looped monitoring the temperature of the battery for the indication of the ECTR event and maintain the aerosol generation device 100 in the operable state when the loop count reaches n.

However, the controller 102 can control the aerosol generation device to perform the action when the indication of the ECTR event is detected in one of the n loops (i.e., as in step 303).

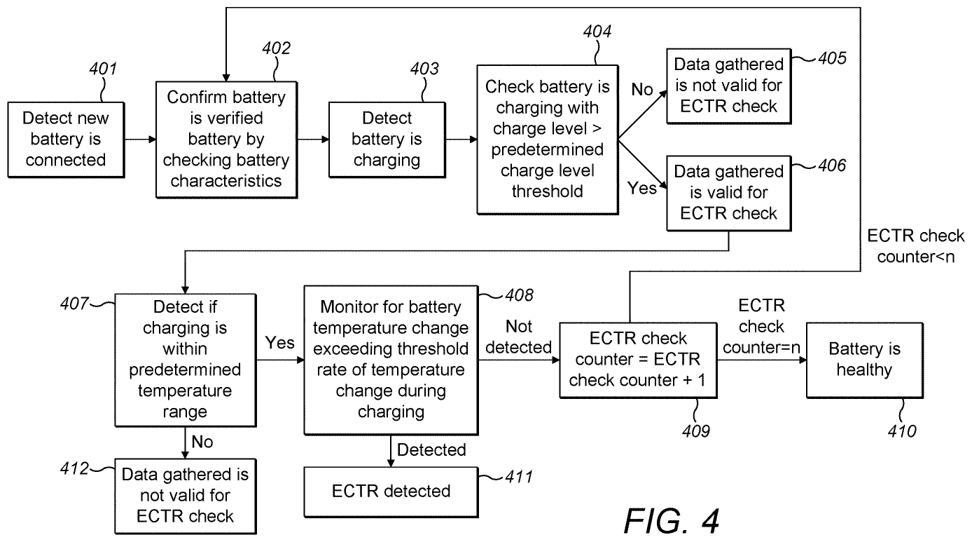

In more detail, an exemplary looped manner for testing a newly connected battery for an ECTR event is presented in FIG. 4. The processes and teaching described with reference to FIG. 3 can all be implemented in the process of FIG. 4; for brevity, however, this is not all repeated here for FIG. 4.

At step 401, the controller 102 can detect that a new battery has been connected. For example, the controller 102 can detect this through a sensor that indicates a connection to a battery 104 has been made. The process then proceeds to step 402.

At step 402, the controller 102 can confirm that the battery is a verified type of battery by checking the characteristics of the battery 104. A verified type of battery is a battery that the controller 102 determines is suitable for use in the aerosol generation device 100. When the controller 100 determines that that the battery 104 is not a verified type of battery, the controller 102 can control the aerosol generation device to be locked or deactivated so that the aerosol generation device 100 is not usable with the unverified battery; this improves safety in the operation of the aerosol generation device 100. When the controller 102 determines that the battery 104 is a verified type of battery, the process continues to step 403.

In some examples, step 402 can be optional, and the process can continue from step 401 directly to step 403 if step 402 is not included.

At step 403, the controller 102 can detect whether the battery 104 is charging. If the battery 104 is not charging, the process can be held until the battery 104 is charging. When the battery 104 is charging, the process continues to step 404.

At step 404, the controller 102 can determine whether the battery 104 is charging with a charge level that is above the predetermined charge level threshold.

When the battery 104 is not charging with a charge level that is above the predetermined charge level threshold, the process continues to step 405. At step 405 the controller can determine that the data gathered is not valid for an ECTR event check. This is because an ECTR event occurs at the end of the charging cycle, and so only monitoring for an ECTR event at the end of the charge cycle (i.e., when the charge level of the battery is above the predetermined charge level threshold) reduces the likelihood of detecting a false positive ECTR event due to temperature changes that occur at points in the charging cycle other than at the end-of-charge. At step 405, the process can be put on hold until the battery 104 is charging with a charge level that is above the predetermined charge level threshold.

When the battery 104 is charging with a charge level that is above the predetermined charge level threshold, the process continues to step 406. At step 406 the controller 102 can determine that the data gathered is valid for an ECTR event check. This is because the battery 104 is approaching the end-of-charge as defined by the charge level exceeding the predetermined charge level threshold, and as such the charge level is in a range in which an ECTR event may occur. The process the proceeds to step 407.

At step 407, the controller 102 can determine whether the battery 104 is operating within the predetermined temperature range during charging. When the temperature of the battery 104 is within the predetermined temperature range, the process proceeds to step 408. When the temperature of the battery 104 is not within the predetermined temperature range, the process continues to step 412.

At step 407 other temperature checks may also be carried out.

Another temperature sensor can measure ambient temperature, this could for example be in a microcontroller unit of the aerosol generation device, and can be used for a plausibility check. If the ambient temperature is outside of an allowable ambient temperature range, the battery temperature data can be considered invalid for an ECTR check. On the other hand, if the ambient temperature is within an allowable ambient temperature range, the battery temperature data can be considered valid for an ECTR check and the process can proceed to step 408.

The rate of ambient temperature change can also be used for a plausibility check. If the ambient temperature change in a given unit of time exceeds an ambient temperature change threshold, the battery temperature data can be considered invalid for an ECTR check. On the other hand, if the ambient temperature change in a given unit of time does not exceed an ambient temperature change threshold, the battery temperature data can be considered valid for an ECTR check and the process can proceed to step 408. This additional plausibility check can be used for slow charging implementations e.g. using 1 C rate for the battery. Fast charging implementations could heat the device in a way that could cause the ambient temperature sensor to sense increased temperature due to internal heat up of the device (e.g. through charging IC). In this case, this ambient temperature change check should be deactivated by the controller.

In examples where multiple types of temperature check are performed at step 407, all of said temperature checks should correspond to valid battery temperature data for the process to proceed to step 408.

In some examples, the order of the checks at steps 404 and 407 can be reversed. That is, the check of whether the battery is charging with a charge level that exceeds the predetermined charge level threshold (step 404) could take place after determining whether the battery temperature is within the predetermined temperature range during charging.

At step 412, when the battery temperature is not within the predetermined temperature range, the controller 102 can determine that the data is considered not valid for an ECTR check. The process of FIG. 4 can then be aborted, or held at step 407 until the battery temperature is within the predetermined temperature range.

At step 408, the controller 102 can monitor the temperature of the battery during charging, using the battery temperature sensor 106, by measuring the temperature of the battery 104 at predetermined time intervals during the charging to detect whether the rate of change of the battery temperature exceeds the predetermined threshold rate of temperature change (as at step 302 of FIG. 3).

When the controller 102 detects that rate of change of the battery temperature exceeds the predetermined threshold rate of temperature change, an ECTR event is detected and the process proceeds to step 411.

At step 411, in response to an ECTR event being detected, the controller 102 can control the aerosol generation device 100 to perform the aforementioned action (as at step 303 of FIG. 3).

When the controller 102 detects that rate of change of the battery temperature does not exceed the predetermined threshold rate of temperature change during the charging session, the process proceeds to step 409.

At step 409, the controller 102 can update an ‘ECTR check counter’ by increasing the counter by one (that is: ECTR check counter=ECTR check count+1). The ECTR check counter can be stored in storage accessible by the controller 102. That is, the counter is increased by one for each battery charging session in which an ECTR event is not detected.

When, after updating the ECTR check counter, the ECTR check counter has reached the value of n (that is: ECTR check counter=n), the process continues to step 410.

At step 410, when the ECTR check counter is equal to n, the controller 102 can determine that the battery 104 is in good health because n charging sessions for the new battery have been successfully carried out without an ECTR event having been detected. After this, the controller 102 maintains the aerosol generation device 100 in an operable state and does not control the aerosol generation device 100 to perform the action. In some examples, no further ECTR checks are made until another new battery is connected. In other examples, as will be discussed, the controller 102 can continue performing an ECTR check each time the battery 104 is charged.

Returning to step 409, when after updating the ECTR check counter, the ECTR check counter has a value of less than n (that is: ECTR check counter<n), the process continues to step loops back to step 402, and the looped process of FIG. 4 is repeated in the next battery charging session. That is, each loop corresponds to one battery charging session. In this way, the newly connected battery can be checked for degradation across a predetermined number of charging sessions (n).

Alternatively, or additionally, to detecting for an ECTR event when a new battery is connected (i.e., in the aforementioned n loops), the controller 102 can be configured to detect for an ECTR event each time the battery 104 is charged. That is to say, the process described with reference to FIG. 3 can take place each time the battery is charged (e.g., beyond the n loops) to monitor whether an ECTR event occurs. In this way, the battery 104 can be checked for degradation indicated by an ECTR event throughout its working life.

The processing steps described herein carried out by the controller 102 may be stored in a non-transitory computer-readable medium, or storage, associated with the controller 102. A computer-readable medium can include non-volatile media and volatile media. Volatile media can include semiconductor memories and dynamic memories, amongst others. Non-volatile media can include optical disks and magnetic disks, amongst others.

It will be readily understood to the skilled person that the preceding embodiments in the foregoing description are not limiting; features of each embodiment may be incorporated into the other embodiments as appropriate. It will also be understood that the steps of the processes described with reference to FIGS. 3 and 4 need not be carried out in the order described, but can instead be carried out in any suitable order.

1. An aerosol generation device comprising:
a battery module;
a battery temperature sensor;
a battery charge sensor; and
a controller configured to:
monitor the charge level of the battery during charging of the battery using the battery charge sensor;
monitor a temperature of the battery during charging of the battery using the battery temperature sensor to detect an indication of an end-of-charge temperature rise in the monitored battery temperature;
determine whether the indication of the end-of-charge temperature rise has been detected in the monitored battery temperature only when it is determined that the monitored charge level of the battery has exceeded a predetermined charge level threshold;
control the aerosol generation device to perform an action when the indication of the end-of-charge temperature rise is detected; and
maintain the aerosol generation device in an operable state and not control the aerosol generation device to perform the action when the indication of the end-of-charge temperature rise is not detected.

2. The aerosol generation device of claim 1, wherein the indication of an end-of-charge temperature rise comprises an increase in the temperature of the battery exceeding a threshold rate of temperature change.

3. The aerosol generation device of claim 2, wherein the controller is configured to monitor the temperature of the battery during charging of the battery using the battery temperature sensor by measuring the temperature of the battery at predetermined time intervals during the charging; and
detect the indication of an end-of-charge temperature rise in the temperature of the battery measured at the predetermined time intervals when an increase in the temperature of the battery exceeds the threshold rate of temperature change.

4. The aerosol generation device of claim 1, wherein the battery charge sensor further comprises a battery charge level monitoring subcircuit, and the controller is configured to determine the charge level of the battery using the battery charge level monitoring subcircuit; and the controller is further configured to
not monitor the temperature of the battery during charging of the battery to detect an indication of the end-of-charge temperature rise in the monitored battery temperature when the charge level of the battery does not exceed the predetermined charge level threshold.

5. The aerosol generation device of claim 1, wherein the controller is configured to determine whether the temperature of the battery is within a predetermined temperature range, and the controller is further configured to:
monitor the temperature of the battery during charging of the battery to detect the indication of an end-of-charge temperature rise during the charging of the battery when the temperature of the battery is within the predetermined temperature range; and
not monitor the temperature of the battery during charging of the battery to detect an indication of the end-of-charge temperature rise during the charging of the battery when the temperature of the battery is not within the predetermined temperature range.

6. The aerosol generation device of claim 1, wherein in response to a new battery being connected to the aerosol generation device, the controller is configured to repeatedly, in a looped manner wherein each loop corresponds to a separate and consecutive battery charging cycle, monitor the temperature of the battery when charging to detect an indication of an end-of-charge temperature rise in the monitored battery temperature and determine whether the indication of the end-of-charge temperature rise has been detected; and
maintain the aerosol generation device in the operable state when the indication of the end-of-charge temperature rise is not detected in n loops, wherein n has a predetermined value that is integer greater than 1; and
control the aerosol generation device to perform the action when the indication of the end-of-charge temperature rise is detected in the n loops.

7. The aerosol generation device of claim 6, wherein for each loop in which the indication of the end-of-charge temperature rise is not detected, the controller increases a loop count by 1, and the controller is configured to stop the looped monitoring the temperature of the battery for the indication of the end-of-charge temperature rise and maintain the aerosol generation device in the operable state when the loop count reaches n.

8. The aerosol generation device of claim 7, wherein n=5.

9. The aerosol generation device of claim 1, wherein the controller is configured to detect that the battery is charging before monitoring the temperature of the battery during charging of the battery using the battery temperature sensor to detect the indication of an end-of-charge temperature rise in the monitored battery temperature.

10. The aerosol generation device of claim 1, wherein the action comprises providing an output by an indicator of the aerosol generation device indicating that the battery is degraded.

11. The aerosol generation device of claim 1, wherein the action comprises deactivating the aerosol generation device.

12. The aerosol generation device of claim 1, wherein the action comprises:
providing an output by an indicator of the aerosol generation device indicating that the battery is degraded when a detected end-of-charge temperature rise has a rate of temperature change that is greater than a first predetermined rate of temperature change but not greater than a second predetermined rate of temperature change, wherein the second predetermined rate of temperature change is greater than the first predetermined rate of temperature change; and
deactivating the aerosol generation device when a detected end-of-charge temperature rise has a rate of temperature change that is greater than the second predetermined rate of temperature change.

13. The aerosol generation device of claim 12, wherein deactivating the aerosol generation device comprises preventing the device from performing one or more aerosolisation sessions and/or preventing the battery from being charged.

14. The aerosol generation device of claim 1, wherein the controller is configured to determine a fall in the temperature of the battery after the indication of the end-of-charge temperature rise has been detected in the monitored battery temperature, and to control the aerosol generation device to perform an second action when the indication of the end-of-charge temperature rise is detected followed by a fall in the temperature of the battery.

15. A method of monitoring an aerosol generation device battery, the method comprising:
monitoring a temperature of a battery of an aerosol generation device during charging of the battery using a battery temperature sensor of the aerosol generation device to detect an indication of an end-of-charge temperature rise in the monitored battery temperature;
monitor the charge level of the battery during charging of the battery using a battery charge sensor;
determining whether the indication of the end-of-charge temperature rise has been detected in the monitored battery temperature only when it is determined that the monitored charge level of the battery has exceeded a predetermined charge level threshold;
controlling the aerosol generation device to perform an action when the indication of the end-of-charge temperature rise is detected; and
maintaining the aerosol generation device in an operable state and not controlling the aerosol generation device to perform the action when the indication of the end-of-charge temperature rise is not detected.

16. A non-transitory computer-readable medium comprising instructions that when executed by one or more processors of an aerosol generation device cause the processors to:
monitor a temperature of a battery of the aerosol generation device during charging of the battery using a battery temperature sensor of the aerosol generation device to detect an indication of an end-of-charge temperature rise in the monitored battery temperature;
monitor the charge level of the battery during charging of the battery using a battery charge sensor;
determine whether the indication of the end-of-charge temperature rise has been detected in the monitored battery temperature only when it is determined that the monitored charge level of the battery has exceeded a predetermined charge level threshold;
control the aerosol generation device to perform an action when the indication of the end-of-charge temperature rise is detected; and
maintain the aerosol generation device in an operable state and not control the aerosol generation device to perform the action when the indication of the end-of-charge temperature rise is not detected.

17. The aerosol generation device of claim 11, wherein deactivating the aerosol generation device comprises preventing the device from performing one or more aerosolisation sessions and/or preventing the battery from being charged.

18. The aerosol generation device of claim 14, wherein the second action is the same as the first action.
